(19) United States
(12) Patent Application Publication
(10) Pub. No.: US 2007/0127745 A1
(43) Pub. Date: Jun. 7, 2007

(54) Prevention of static bonding between medical device components

(75) Inventors: Peter Gibson, South Coogee (AU); Fysh Dadd, Lane Cove (AU); Claudiu Treaba, Wollstonecraft (AU); Yohan Choi, Miranda (AU)

Correspondence Address: JAGTIANI + GUTTAG, 10363-A DEMOCRACY LANE, FAIRFAX, VA, 22030, US

(73) Assignee: Cochlear Limited, Lane Cove (AU)

(21) Appl. No.: 11/604,854

(22) Filed: Nov. 28, 2006

Related U.S. Application Data
(60) Provisional application No. 60/742,895, filed on Dec. 7, 2005.

(51) Int. Cl. H04R 25/00

(52) U.S. Cl. 381/151

(57) ABSTRACT

A medical device such as a cochlear implant is disclosed, comprising: an elongate electrode carrier member formed of a first material and configured to be implanted in a recipient's cochlea, and having a longitudinally-extending lumen; and an elongate stylet formed of a second material and adapted to be removably inserted into the lumen, comprising an exterior barrier layer configured to minimize static friction by inhibiting atomic bonding of the first and second materials.

### CROSS-REFERENCE TO RELATED APPLICATIONS

This application claims priority from U.S. Provisional Patent Application No. 60/742,895, entitled “A Protective Coating For Medical Device Surfaces” and filed on Dec. 7, 2005, which is hereby incorporated by reference herein.

### BACKGROUND

1. Field of the Invention

The present invention relates generally to medical devices and, more particularly, to preventing static bonding between medical device components.

2. Related Art

The use of medical devices to provide therapy to individuals for various medical conditions has become more widespread as the therapeutic benefits such devices provide become more widely appreciated and accepted throughout the population. In particular, devices such as hearing aids, implantable pacemakers, defibrillators, functional electrical stimulation devices such as prosthetic hearing devices, organ assist or replacement devices, sensors, drug delivery devices and other medical devices, have been successful in performing life saving, lifestyle enhancement or other therapeutic functions for many individuals.

One such type of prosthetic hearing device is a cochlear™ implant system (commonly referred to as cochlear™ devices, cochlear™ implants and the like; “cochlear implant” herein). Cochlear implants provide hearing sensations to individuals suffering from severe to profound hearing loss. Hearing loss in such individuals is typically due to the absence or destruction of the hair cells in the cochlea which transduce acoustic signals into nerve impulses. Cochlear implants essentially simulate the cochlea hair cells by directly delivering electrical stimulation to the auditory nerve fibers. This causes the brain to perceive a hearing sensation resembling the natural hearing sensation normally delivered to the auditory nerve.

It is useful to apply a protective coating to the surface of the above and other medical devices for a number of reasons including but not limited to ensuring that the surface is passive in relation to other materials, to provide electrical insulation, biocompatibility and immobilization of microscopic particles, as well as to provide physical isolation of the device from moisture, chemicals, and other substances.

### SUMMARY

In one aspect of the present invention, a kit is disclosed, comprising: an elongate carrier member formed of a first material and configured to be implanted in a recipient's cochlea, and having a longitudinally-extending lumen; a plurality of electrodes disposed on a distal end of the carrier member; and an elongate stylet, configured to be removably inserted into the lumen, comprising: a core formed of a second material that tends to form static bonds with the first material, and an exterior barrier layer covering at least a portion of the core, the exterior barrier layer being impermeable to the first and second materials.

In another aspect of the present invention, a cochlear implant is disclosed, comprising: an elongate electrode carrier member formed of a first material and configured to be implanted in a recipient's cochlea, and having a longitudinally-extending lumen; and an elongate stylet formed of a second material and adapted to be removably inserted into the lumen, comprising an exterior barrier layer configured to minimize static friction by inhibiting atomic bonding of the first and second materials.

In a further aspect of the present invention, a method for manufacturing a stylet for use with an electrode carrier member of a cochlear implant, comprising: providing a vapour deposition chamber with an elevated support plate having at least one mounting hole disposed therein; providing an elongate stylet core; hanging one or more stylet cores through one of the at least one mounting hole in the elevated support plate; vibrating the support plate; and vapour depositing a polymer onto the stylet during the vibrating of the support plate to form an exterior barrier layer around at least a portion of the stylet.

In a still further aspect of the present invention, a medical device is disclosed, comprising: a first component formed of a first material; a second component formed of a second material that tends to atomically bond with the first material; wherein at least one of either the first and second component has an exterior barrier layer impermeable to the first and second materials thereby impeding the bonding from occurring.

### BRIEF DESCRIPTION OF THE DRAWINGS

Illustrative embodiments of the present invention are described herein with reference to the accompanying drawings, in which:

FIG. 1 is a perspective view of an exemplary cochlear implant in which embodiments of the present invention may be advantageously implemented;

FIG. 2A is a side view of an electrode assembly in accordance with one embodiment of the present invention;

FIG. 2B is a cross-sectional view of one embodiment of the of the electrode assembly illustrated in FIG. 2A taken along section line 2B-2B in FIG. 2A;

FIG. 2C is a cross-sectional view of one embodiment of the electrode assembly illustrated in FIG. 2A taken along section line 2C-2C in FIG. 2A;

FIG. 2D is an enlarged view of a portion of FIG. 2C; and

FIG. 3 is a flow chart illustrating a method for manufacturing one embodiment of the stylet illustrated in FIGS. 2C and 2D, in accordance with one embodiment of the present invention.

### DETAILED DESCRIPTION

The present invention is directed to impeding atomic bonding that tends to occur between surfaces of medical device components that have been in stationary contact with each other. When certain materials are in contact with each other, atoms in the contact surfaces bond together and resist sliding. This bond, also referred to as static or adhesive bond, increases the static friction that must be overcome to slide one component past the other. In accordance with the teachings of the present invention, the contact surface of one component is coated with a barrier material that is impermeable to the materials of the contacting components, thereby inhibiting the atomic bonding of the contact surfaces. This eliminates the contribution of static bonding to static friction thereby reducing the quantity of force required to induce a relative sliding motion of the medical device components.

In certain embodiments, the barrier material is a polymeric material. In one particular embodiment, the barrier material is Parylene™. Parylene™, unlike other polymeric materials, is not manufactured or sold as a polymer. Rather it is produced by vapour-phase deposition and polymerization of para-xylylene or its derivatives. The Parylene™ barrier material is completely conformal, of uniform thickness and pinhole free. It has a very low coefficient of friction and very low permeability. As such, a thin exterior layer of Parylene™ prevents passage of either material through the exterior layer nor does the barrier material contribute significantly to static friction.

The present invention has application to any medical device components which have contact surfaces that slide relative to each other. Such relative movement may occur during operation, implantation, explantation or otherwise, and may be mechanically or manually induced and controlled. Also, one or both of the contacting components may be temporarily or permanently implanted, or utilized in the implantation, operation or explantation of any other implanted medical device component. As an example, one type of medical device which may advantageously utilize the present invention is a stylet utilized to implant an electrode assembly of a cochlear implant.

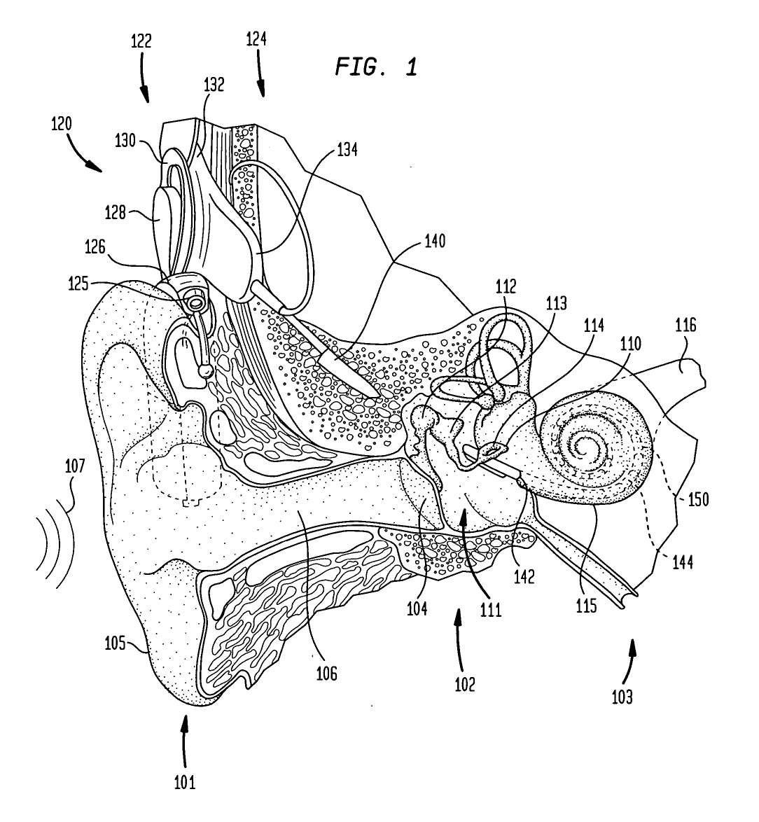

FIG. 1 is a perspective view of an exemplary prosthetic hearing device, a cochlear implant, in which embodiments of the present invention may be advantageously implemented. In fully functional human hearing anatomy, outer ear 101 comprises an auricle 105 and an ear canal 106. A sound wave or acoustic pressure 107 is collected by auricle 105 and channeled into and through ear canal 106.

Disposed across the distal end of ear canal 106 is a tympanic membrane 104 which vibrates in response to acoustic wave 107. This vibration is coupled to oval window or fenestra ovalis 110 through three bones of middle ear 102, collectively referred to as the ossicles 111 and comprising the malleus 112, the incus 113 and the stapes 114. Bones 112, 113 and 114 of middle ear 102 serve to filter and amplify acoustic wave 107, causing oval window 110 to articulate, or vibrate. Such vibration sets up waves of fluid motion within cochlea 115. Such fluid motion, in turn, activates tiny hair cells (not shown) that line the inside of cochlea 115.

Activation of the hair cells causes appropriate nerve impulses to be transferred through the spiral ganglion cells and auditory nerve 116 to the brain (not shown), where they are perceived as sound. In deaf persons, there is an absence or destruction of the hair cells. A cochlear implant such as cochlear implant 120 is utilized to directly stimulate the ganglion cells to provide a hearing sensation to the recipient.

FIG. 1 also shows how a cochlear implant 120 is positioned in relation to outer ear 101, middle ear 102 and inner ear 103. Cochlear implant 120 comprises external component assembly 122 which is directly or indirectly attached to the body of the recipient, and an internal component assembly 124 which is temporarily or permanently implanted in the recipient. External assembly 122 comprises microphone 125 for detecting sound which is outputted to a behind-the-ear (BTE) speech processing unit 126 that generates coded signals. The codes signals are provided to an external transmitter unit 128, along with power from a power source such as a battery. External transmitter unit 128 comprises an external coil 130 and, preferably, a magnet (not shown) secured directly or indirectly in external coil 130.

Internal components 124 comprise an internal receiver unit 132 having an internal coil (not shown) that transcutaneously receives the power and coded signals from external assembly 122, and provides such signals to a stimulator unit 134. In response to the coded signals, stimulator 134 applies stimulation signals to cochlea 115 via an implanted electrode assembly 140. Electrode assembly 140 enters cochlea 115 at cochleostomy region 142 or through oval window 110, and has an array 144 of one or more electrodes 150 positioned to be substantially aligned with portions of tonotopically-mapped cochlea 115. The delivery of stimulation signals at various locations along cochlea 115 causes a hearing percept representative of the received sound 107.

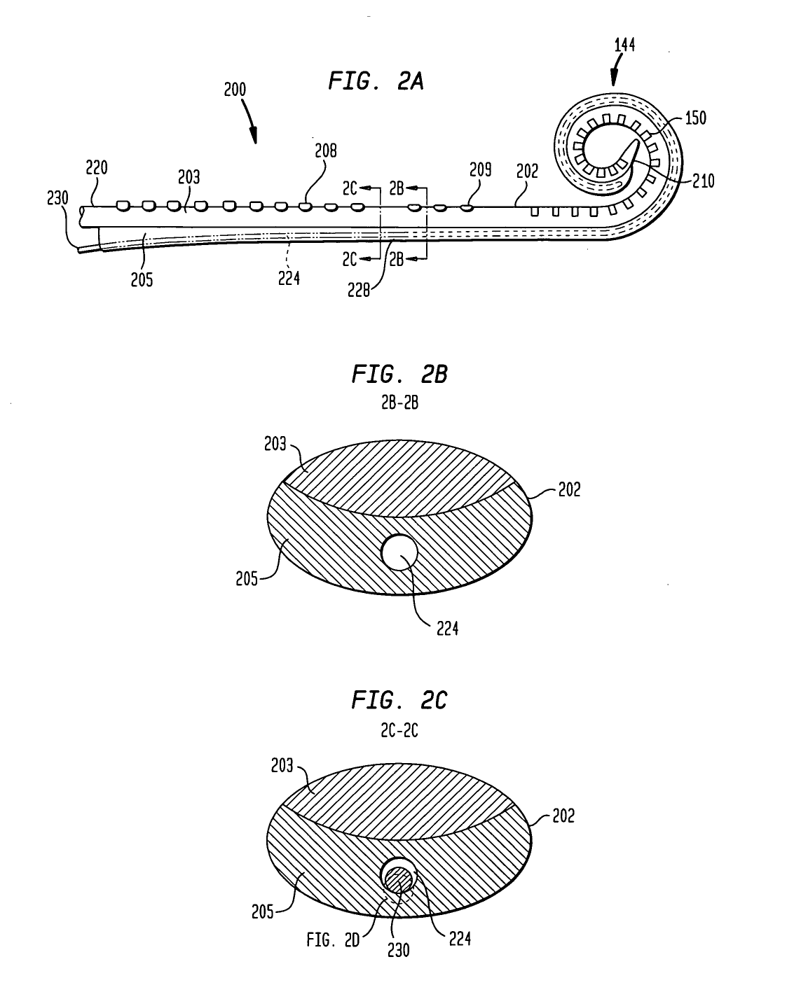

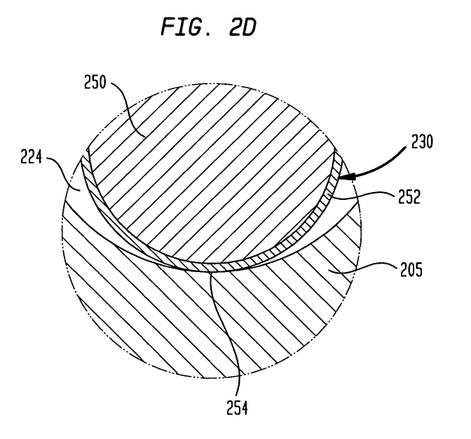

FIG. 2A is a side view of an embodiment of electrode assembly 140 in accordance with one embodiment of the present invention, referred to herein as electrode assembly 200. FIG. 2B is a cross-sectional view of electrode assembly 200 taken along section line 2B-2B in FIG. 2A, while FIG. 2C is a cross-sectional view of the electrode assembly taken along section line 2C-2C in FIG. 2A, and FIG. 2D is a detailed view of a portion of FIG. 2C.

Electrode assembly 200 comprises a carrier member 202 on which array 144 of electrodes 150 is disposed. As noted, each electrode 150 is constructed and arranged to deliver a stimulating signal to a particular region of cochlea 115.

It has been found that the magnitude of the currents flowing from electrodes 150, and the intensity of the corresponding electric fields, are a function of the distance between electrodes 150 and the modiolus (not shown) of cochlea 115. If this distance is relatively great, the threshold current magnitude must be larger than if this distance is relatively small. Moreover, the current from each electrode 150 may flow in a number of directions, and the electrical fields corresponding to adjacent electrodes may overlap, thereby causing cross-electrode interference. To reduce such adverse effects, it is advisable to maintain a minimal distance between carrier member 202 and the modiolus. This is best accomplished by providing carrier member 202 in a shape which generally follows the shape of the modiolus, or inside wall of cochlea 115. This increases the effectiveness of the delivery of electrical stimulation to auditory nerve 116.

In this exemplary embodiment, to position electrodes 150 adjacent the inside wall of cochlea 115, carrier member 202 adopts a curled or spiral position immediately following implantation into cochlea 115. It is also desirable that carrier member 202 be shaped such that the insertion process causes minimal trauma to the sensitive structures of cochlea 115. As such, carrier member 202 is manufactured to be pre-curved. Specifically, carrier member 202 is manufactured to have a spiral configuration; that is, one or more concentric circles that approximate the curvature of cochlea 115.

Usually carrier member 202 is held in a generally straight configuration at least during the initial stages of the insertion procedure, conforming to the natural shape of cochlea 115 once implantation is complete. To have carrier member 202 assume a generally straight configuration, a lumen 224 is provided in the carrier member, as shown in FIGS. 2A and 2C. In the illustrative application of carrier member 202, lumen 224 extends through a substantial portion of the length of carrier member 202. In another embodiment, carrier member 202 includes a non-communicative lumen that extends through a portion of carrier member 202, as described in U.S. patent application Ser. No. 11/268,592, which is hereby incorporated by reference herein.

Lumen 224 is configured to receive a stiffening element 230 commonly referred to in the context of prosthesis hearing implants as a stylet. Although such reference is used in connection with prosthetic hearing devices, it should be appreciated that the term “stylet” is not limiting to any particular application or configuration.

Prior to implanting carrier member 202, stylet 230 is inserted into lumen 224 to maintain electrode array 200 in a straight configuration. While electrode assembly 200 is inserted through cochleostomy 142 or oval window 110, a surgeon biases forward carrier member 202 on stylet 230 to allow carrier member 202 to return to its spiral configuration and, in doing so, to follow the curvature of cochlea 115. In other words, during insertion, stylet 230 is withdrawn from lumen 224 thereby allowing carrier member 202 to return to its pre-curved configuration.

In one embodiment, the technique for implanting electrode assembly 200 is the Advance Off-Stylet™ technique for the Contour™ Advance electrode (previously referred to as the Contour™ Electrode with Softip). In a another embodiment, electrode assembly 200 includes a Contour™ Advance Electrode, also described as Contour™ Electrode with Softip, Modified Tip, or Ski Tip. In another embodiment, the stylet is an Arrow Stylet, Surgical Stylet, or Surgical Ball Stylet. In these and other stylets and electrode carrier members, the stylet is removably inserted into the lumen of the carrier member prior to implantation, and is removed from the carrier member during implantation.

Because implantation of an electrode assembly is a delicate procedure that requires the surgeon to use precise touch and control, any interference may increase the risk of injury to the recipient. The inventors have observed that at times the force required to withdraw a stylet from a carrier member is greater than anticipated, and have concluded that this may adversely affect a surgeon's tactile control during implantation. For example, as a stylet is removed from a carrier member lumen, damage to delicate structures in the cochlea is possible if an increased withdrawal force causes the surgeon to implant the carrier member at an inappropriate rate or orientation. Likewise, injury to the recipient may occur if the surgeon does not withdraw the stylet at the appropriate end point or at the proper rate during insertion of the carrier member.

The inventors further determined that static friction is unproportionally larger than the kinetic or dynamic friction between the stylet and carrier member. Thus, although a larger force is required to induce motion, little force is required to maintain such motion. The inventors determined that of the various factors that may contribute to static friction, atomic bonding of the stylet and carrier member is a significant contributor. In many instances the stylet is inserted into the carrier member when the components are manufactured and/or stored for future use. This continued stationary contact of the stylet and carrier member facilitates the atomic bonding of the stylet and carrier member. This bonding is also significant because the pre-curved carrier member presses the lumen against the stylet. This increased compression force also facilitates atomic bonding. Furthermore, the surface area of the contact surfaces may be significant due to the length of the carrier member and stylet. The greater surface area increases static friction due to such atomic bonding.

Referring to FIG. 2D, in one embodiment of the present invention, stylet 230 comprises a core rigid element 250. In certain embodiments, stylet core 250 is formed of platinum. Platinum wire stylets such as those described in U.S. Pat. No. 6,421,569 and U.S. patent application Ser. Nos. 10/203,079, 10/505,075, 10/825,360, 11/268,592, the entire contents and disclosures of which are hereby incorporated by reference herein, tend to form atomic bonds with carrier member 205 when the carrier member is formed of silicone.

To prevent such atomic bonding from occurring, stylet 230 also comprises an exterior layer 252 of a barrier material. Exterior barrier layer 252 is formed of a material that inhibits the atomic bonding of the platinum core 250 and silicone carrier member 205, and also does not itself bond with the silicone carrier member. This prevents atomic bonding from contributing to the static friction between stylet 230 and carrier member 205, thereby reducing the quantity of force required to induce a relative sliding motion of the two components.

In one embodiment, exterior barrier layer 252 has a uniform thickness, conforms to the surface of stylet core 250, and has very low permeability. In certain embodiments, the barrier material is a polymeric material. In one particular embodiment, the barrier material is Parylene™. Parylene™, unlike other polymeric materials, is not manufactured or sold as a polymer. Rather it is produced by vapour-phase deposition and polymerization of para-xylylene or its derivatives such as Di-chloro Di-P-Xylylene. Parylene™ is a vacuum-deposited polymer. The coating is stable, causes minimal or no change in the component response characteristics and isolates surfaces electrically and chemically from body fluids, moisture and ionic contaminants and is relatively easy to apply over in a thin and consistent layer.

In certain embodiments of the present invention, exterior barrier layer 252 is formed on the entire stylet 230. In other embodiments, only that portion of stylet 230 that may be placed in lumen 224 have an exterior barrier layer 252. In one embodiment, exterior barrier layer 252 has a thickness of approximately 2 microns. In another embodiment, exterior barrier layer 252 has a thickness of less than approximately 2 microns, and at times between approximately 1 and approximately 2 microns. In another embodiment, exterior barrier layer 252 has a thickness of between approximately 4 and approximately 7 microns. In a further embodiment, exterior barrier layer 252 has a thickness of between approximately 3.5 and approximately 10 microns. It should be appreciated, however, that the thickness of exterior barrier layer 252 is dependent on the different in the diameter of lumen 224 and the diameter of stylet 230. It should also be appreciated that the thickness of exterior barrier layer 252 need not be consistent across the entire length of stylet 230 to which it is applied. For example, in certain embodiments, exterior barrier layer 252 is thicker in those regions of the contact surfaces which are expected to experience greater friction.

During traditional Parylene Coating techniques the stylets are supported with, for example, a clamp. During coating a continuous layer of Parylene is formed between the clamp and the stylet. When the stylet is released from the clamp this layer would need to be removed. The stylet region around this layer is referred to as the ‘Parylene Stop Point’.

There are two issues related to the Parylene Stop Point. First, a proper cutting operation would be time consuming and thus expensive. Second, when the stylets are removed from the clamp, the Parylene will tend to lift from the stylet near the Parylene Stop Point. This will further affect the appearance of the Stylet, reduce the Parylene adherence in the region and possibly increase the risk of Parylene flaking off the stylet.

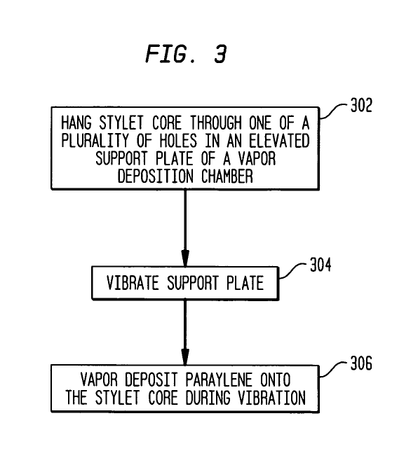

FIG. 3 is a flowchart of the operations performed to manufacture a stylet of the present invention in accordance with one embodiment of the present invention. At block 302, stylet core 250 is hung through one of a plurality of holes in an elevated support plate of a Parylene™ coating chamber. At block 304 the support plate is vibrated. During vibration, Parylene is vapour deposited onto the stylet. Advantageously, the flow of Parylene monomer vapour combined with the Parylene stand vibration determines a random motion of the Stylets relative o the mounting holes. As a result, a continuous, pinhole-free coating is achieved that is uniform; that is, does not have a Parylene Stop Point.

The preferred size of the holes in the support plate varies with the size of stylet core 250 and the desired thickness of exterior barrier layer 252. In one embodiment, to form an exterior barrier layer 252 having a thickness of 5 microns on a stylet core 250 having a diameter of 0.125 millimeters and a head of 0.9 millimeters, a pinhole of 0.4+/−0.1 millimeters is preferred. In alternative embodiments, pinholes of 0.2 to 0.6 millimeters are also effective. It should be appreciated, however, that any pinhole that is relatively larger than the stylet and smaller than the stylet head may be effectively implemented in this method of the present invention.

All documents, patents, journal articles and other materials cited in the present application are hereby incorporated by reference herein.

Although the present invention has been fully described in conjunction with several embodiments thereof with reference to the accompanying drawings, it is to be understood that various changes and modifications may be apparent to those skilled in the art. It should be understood that embodiments of the present invention may provide a combination of one or more of the above or other advantages, and that the disclosed embodiments need not provide each of the above advantages. It should also be understood that the present invention may be utilized in connection with any medical device now or later developed that may be implanted temporarily or permanently into a patient, or devices used in connection with the delivery or removal of devices, fluids, or other materials to or from a recipient. Such changes and modifications are to be understood as included within the scope of the present invention as defined by the appended claims, unless they depart therefrom.

What is claimed is:

1. A kit comprising:
an elongate carrier member formed of a first material and configured to be implanted in a recipient's cochlea, and having a longitudinally-extending lumen;
a plurality of electrodes disposed on a distal end of said carrier member; and
an elongate stylet, configured to be removably inserted into said lumen, comprising:
a core formed of a second material that tends to form static bonds with said first material, and
an exterior barrier layer covering at least a portion of said core, said exterior barrier layer being impermeable to said first and second materials.

2. The kit of claim 1, wherein said exterior barrier layer is formed of a polymeric material.

3. The kit of claim 2, wherein said polymeric material is Parylene™.

4. The kit of claim 1, wherein said exterior barrier layer has a substantially uniform thickness.

5. The kit of claim 1, wherein said carrier member has a pre-curved shape that generally follows the shape of the modiolus of the cochlea.

6. The kit of claim 1, wherein said stylet core is formed of platinum and said carrier member is formed of silicone.

7. The kit of claim 1, wherein said exterior barrier layer has a thickness of approximately 2 microns.

8. The kit of claim 1, wherein said exterior barrier layer has a thickness of less than 2 microns.

9. The kit of claim 1, wherein said exterior barrier layer has a thickness of between approximately 1 and approximately 2 microns.

10. The kit of claim 1, wherein said exterior barrier layer has a thickness of between approximately 4 and approximately 7 microns.

11. The kit of claim 1, wherein said exterior barrier layer has a thickness of between approximately 3.5 and approximately 10 microns.

12. The kit of claim 1, wherein said exterior barrier layer has a thickness that is not consistent along the length of said stylet.

13. A cochlear implant comprising:
an elongate electrode carrier member formed of a first material and configured to be implanted in a recipient's cochlea, and having a longitudinally-extending lumen; and
an elongate stylet formed of a second material and adapted to be removably inserted into said lumen, comprising an exterior barrier layer configured to minimize static friction by inhibiting atomic bonding of said first and second materials.

14. The cochlear implant of claim 13, wherein said stylet core is formed of platinum, said carrier member is formed of silicone, and said exterior barrier layer is formed of a polymeric material.

15. The cochlear implant of claim 13, wherein said exterior barrier layer is formed of Parylene™.

16. The cochlear implant of claim 13, wherein said exterior barrier layer has a substantially uniform thickness.

17. The cochlear implant of claim 13, wherein said exterior barrier layer has a thickness of approximately 2 microns.

18. The cochlear implant of claim 13, wherein said exterior barrier layer has a thickness of less than 2 microns.

19. The cochlear implant of claim 13, wherein said exterior barrier layer has a thickness of between approximately 1 and approximately 2 microns.

20. The cochlear implant of claim 13, wherein said exterior barrier layer has a thickness of between approximately 4 and approximately 7 microns.

21. The cochlear implant of claim 13, wherein said exterior barrier layer has a thickness of between approximately 3.5 and approximately 10 microns.

22. A method for manufacturing a stylet for use with an electrode carrier member of a cochlear implant, comprising:
providing a vapour deposition chamber with an elevated support plate having at least one mounting hole disposed therein;
providing an elongate stylet core;
hanging one or more stylet cores through one of said at least one mounting hole in said elevated support plate;
vibrating said support plate; and
vapour depositing a polymer onto said stylet during said vibrating of said support plate to form an exterior barrier layer around at least a portion of said stylet.

23. The method of claim 22, wherein said at least one mounting hole has a diameter that is greater than the diameter of said stylet and less than the length/width/head of said stylet.

24. The method of claim 23, wherein said stylet has a diameter of 0.125 millimeters and a head of 0.9 millimeters, and wherein said at least one mounting hole has a diameter of between approximately 0.2 and approximately 0.6 millimeters.

25. The method of claim 24, wherein said stylet has a diameter of 0.125 millimeters and a head of 0.9 millimeters, and wherein said at least one mounting hole has a diameter of approximately 0.4+/−0.1 millimeters.

26. The method of claim 22, wherein said exterior barrier layer is formed of a polymeric material.

27. The method of claim 26, wherein said polymeric material is Parylene™.

28. The method of claim 22, wherein said exterior barrier layer has a substantially uniform thickness.

29. The method of claim 22, wherein said stylet core is formed of platinum and said carrier member is formed of silicone.

30. The method of claim 22, wherein said exterior barrier layer has a thickness of approximately 2 microns.

31. The method of claim 22, wherein said exterior barrier layer has a thickness of less than 2 microns.

32. The method of claim 22, wherein said exterior barrier layer has a thickness of between approximately 1 and approximately 2 microns.

33. The method of claim 22, wherein said exterior barrier layer has a thickness of between approximately 4 and approximately 7 microns.

34. The method of claim 22, wherein said exterior barrier layer has a thickness of between approximately 3.5 and approximately 10 microns.

35. The method of claim 22, wherein said exterior barrier layer has a thickness that is not consistent along the length of said stylet.

36. A medical device comprising:
a first component formed of a first material;
a second component formed of a second material that tends to atomically bond with said first material;
wherein at least one of either the first and second component has an exterior barrier layer impermeable to said first and second materials thereby impeding said bonding from occurring.

37. The medical device of claim 40, wherein said barrier material is a polymeric material.

38. The medical device of claim 40, wherein said polymeric material is Parylene™.
